(19) United States
(12) Patent Application Publication
(10) Pub. No.: US 2024/0308365 A1
(43) Pub. Date: Sep. 19, 2024

(54) ULTRA-FAST CHARGING METHOD FOR FORKLIFT BATTERY

(71) Applicant: Green Cubes Technology, LLC, Kokomo, IN (US)

(72) Inventor: MOHAMMED ALOBAIDI, Kokomo, IN (US)

(73) Assignee: Green Cubes Technology, LLC, Kokomo, IN (US)

(21) Appl. No.: 18/272,656

(22) PCT Filed: Jan. 12, 2022
(86) PCT No.: PCT/US2022/012209

§ 371 Date: Jul. 17, 2023

Related U.S. Application Data
(60) Provisional application No. 63/138,044, filed on Jan. 15, 2021.

(51) Int. Cl. B60L 53/22; B60L 53/10; B60L 53/16; B66F 9/24; H01M 10/0525; H01M 10/42; H01M 10/44; H01M 10/46

(52) U.S. Cl. CPC B60L 53/22; B60L 53/11; B60L 53/16; B66F 9/24; H01M 10/0525; H01M 10/425; H01M 10/44; H01M 10/46; B60L 2200/42; B60L 2210/10; B60L 2210/30; H01M 2010/4271; H01M 2220/20

(57) ABSTRACT

Electric powered forklifts or cleaning machine have attracted much attention in the last decade because of their very substantial benefits. The main issue facing the efficiency of Electric forklifts is the charging time needed for the battery pack. To achieve the Ultra-fast charging for the battery. An AC-DC or DC-DC converter is added inside the battery compartment. The converter enables the charger to supply high power and voltage as the converter step-down the voltage to the standard battery voltage. By using this method, the charging time will be reduced without using big or bulky cables.

### PRIORITY

The present patent application is related to, and claims the priority benefit of, U.S. Provisional Patent Application Ser. No. 63/138,044, filed on Jan. 15, 2021 the contents of which are hereby incorporated by reference in their entirety into this disclosure.

### BACKGROUND

Electric powered forklifts have attracted much attention in the last decade because of their very substantial benefits to the consumer in term of economic aspect, safety and maintenance. Although most of the industrial customers have started to replace the internal combustion forklift with their electric powered counterparts, some of them still use the internal combustion (IC) forklift and cleaning machines because of their low, or minimal, downtime. The main issue facing the efficiency of electric forklifts and cleaning machines is the charging time needed for the battery pack. The conventional way is by plugging the forklift to the charger for a few hours and unplugging it when it finishes charging, or one of the staff members switches the empty battery with another full one to reduce the down time of the machine. This process takes a long time and introduces redundancies that reduce the efficiency in the work place. To charge the battery faster, a very high current is needed. This charging can be done by using very large and bulky cables and connectors.

Thus, there is a need for a solution that reduces downtime by making the process of swapping and/or charging a forklift battery faster and easier, and therefore more efficient. A solution that allows for faster charging of battery powered industrial vehicles and equipment without the use of large cables and connectors would be well received in the marketplace.

### BRIEF SUMMARY

By adding a converter inside the battery compartment, the charger or wall socket can inject a high power to the system by maintaining a high voltage (AC or DC) which is stepped down to the standard battery voltage (high current) by using the built-in converter. The battery receives the power through a busbar to be able to withstand the high current from the converter. This process reduces the charging time required from the forklift, minimizes the cable's size and adds more efficiency to the work flow.

The present disclosure includes disclosure of a battery positioned within a battery housing in a electric vehicle, comprising a frame or battery compartment; a lithium ion battery pack; a battery management system (BMS); an AC-DC converter; busbars; and a cable connectors; wherein the battery is charged by a single phase or three phase AC source.

The present disclosure includes disclosure of a battery positioned within a battery housing in a electric vehicle, comprising: a frame or battery compartment; a lithium ion battery pack; a battery management system (BMS); a DC-DC converter; busbars; and a cable connectors; wherein the battery is charged by an external high voltage charger.

The present disclosure includes disclosure of a battery positioned within a battery housing in a electric vehicle, comprising a frame or battery compartment; a lithium ion battery pack; a battery management system (BMS); an AC-DC converter and a DC-DC converter; busbars; and a cable connectors; wherein the battery is charged by a single phase or three phase AC source.

The present disclosure includes disclosure of a battery comprising battery cells connected in series and/or parallel to obtain a desired voltage and capacity.

The present disclosure includes disclosure of a battery wherein the BMS further comprises Wi-Fi, Bluetooth Low Energy (BLE), NFC and/or GPS therein.

The present disclosure includes disclosure of a battery wherein the battery further comprises a cord for plugging into a wall outlet or charger for recharging.

The present disclosure includes disclosure of a battery further comprising an artificial intelligence hub securely mounted to frame and operably coupled to the rechargeable lithium battery.

The present disclosure includes disclosure of a battery wherein the busbars comprise extra cables to connect to the battery.

The present disclosure includes disclosure of a battery wherein the busbars may be replaced with thick cables.

The present disclosure includes disclosure of a battery configured for use with Automated Guided Vehicles (AGVs), Ground Support Equipment (GSE) and Industrial Electric Vehicles.

The present disclosure includes disclosure of a battery for use within an electric vehicle, comprising a battery pack; a battery management system; a connection for connecting the battery to a power source; a converter for converting a voltage from the power source to a battery voltage; and at least one busbar connecting the converter to the battery pack.

The present disclosure includes disclosure of a battery for use within an electric vehicle, wherein the battery pack is a lithium ion battery pack.

The present disclosure includes disclosure of a battery for use within an electric vehicle wherein the lithium ion battery pack comprises a plurality of lithium ion batteries connected in parallel.

The present disclosure includes disclosure of a battery for use within an electric vehicle wherein the lithium ion battery pack comprises a plurality of lithium ion batteries connected in series.

The present disclosure includes disclosure of a battery for use within an electric vehicle wherein the power source is a high voltage power source.

The present disclosure includes disclosure of a battery for use within an electric vehicle wherein the converter is built into the battery.

The present disclosure includes disclosure of a battery for use within an electric vehicle wherein the converter is a DC-DC converter, which steps down the voltage from the power source to the battery source voltage.

The present disclosure includes disclosure of a battery for use within an electric vehicle wherein the converter is an AC-DC converter.

The present disclosure includes disclosure of a battery for use within an electric vehicle wherein the power source is a DC charger.

The present disclosure includes disclosure of a battery for use within an electric vehicle wherein the connection is an AC wall plug to connect to a power grid.

The present disclosure includes disclosure of a battery for use within an electric vehicle wherein the power source is a three-phase power source.

The present disclosure includes disclosure of a battery for use within an electric vehicle wherein the power source is a single phase power source.

The present disclosure includes disclosure of a battery for use within an electric vehicle wherein the connection comprises a charging cable and an AC plug.

The present disclosure includes disclosure of a battery for use within an electric vehicle wherein the at least one busbar comprises a copper plate.

The present disclosure includes disclosure of a battery for use within an electric vehicle wherein the at least one busbar comprises a hard wire from the converter's output to the battery pack.

The present disclosure includes disclosure of a battery for use within an electric vehicle wherein the battery management system is connected to the built-in converter and includes Wi-Fi, Bluetooth Low Energy, Near Field Communication, and/or GPS.

The present disclosure includes disclosure of a forklift having a rechargeable battery, the rechargeable battery comprising a battery pack; a battery management system; a connection for connecting the battery to a power source; a converter for converting a voltage from the power source to a battery voltage; and at least one busbar connecting the converter to the battery pack.

The present disclosure includes disclosure of a forklift having a rechargeable battery wherein the battery pack is a lithium ion battery pack.

The present disclosure includes disclosure of a forklift having a rechargeable battery wherein the lithium ion battery pack comprises a plurality of lithium ion batteries connected in parallel.

The present disclosure includes disclosure of a forklift having a rechargeable battery wherein the lithium ion battery pack comprises a plurality of lithium ion batteries connected in series.

The present disclosure includes disclosure of a forklift having a rechargeable battery wherein the power source is a high voltage power source.

The present disclosure includes disclosure of a forklift having a rechargeable battery wherein the converter is built into the battery.

The present disclosure includes disclosure of a forklift having a rechargeable battery wherein the converter is a DC-DC converter, which steps down the voltage from the power source to the battery source voltage.

The present disclosure includes disclosure of a forklift having a rechargeable battery wherein the converter is an AC-DC converter.

The present disclosure includes disclosure of a forklift having a rechargeable battery wherein the power source is a DC charger.

The present disclosure includes disclosure of a forklift having a rechargeable battery wherein the connection is an AC wall plug to connect to a power grid.

The present disclosure includes disclosure of a forklift having a rechargeable battery wherein the power source is a three-phase power source.

The present disclosure includes disclosure of a forklift having a rechargeable battery wherein the power source is a single phase power source.

The present disclosure includes disclosure of a forklift having a rechargeable battery wherein the connection comprises a charging cable and an AC plug.

The present disclosure includes disclosure of a forklift having a rechargeable battery wherein the at least one busbar comprises a copper plate.

The present disclosure includes disclosure of a forklift having a rechargeable battery wherein the at least one busbar comprises a hard wire from the converter's output to the battery pack.

The present disclosure includes disclosure of a forklift having a rechargeable battery wherein the battery management system is connected to the built-in converter and includes Wi-Fi, Bluetooth Low Energy, Near Field Communication, and/or GPS.

### BRIEF DESCRIPTION OF THE DRAWINGS

The disclosed embodiments and other features, advantages, and disclosures contained herein, and the matter of attaining them, will become apparent and the present disclosure will be better understood by reference to the following description of various exemplary embodiments of the present disclosure taken in conjunction with the accompanying drawings, wherein:

FIG. 1A illustrates a perspective view of an exemplary embodiment of a forklift system, having a forklift, battery pack and charger.

FIG. 1B illustrates a perspective view of an exemplary embodiment of a forklift system, having a forklift, battery pack and wall plug.

FIG. 2 illustrates a perspective view of an exemplary embodiment of a forklift battery, having a battery pack, Battery Management System (BMS), AC-DC or DC-DC converter and busbars.

As such, an overview of the features, functions and/or configurations of the components depicted in the various figures will now be presented. It should be appreciated that not all of the features of the components of the figures are necessarily described and some of these non-discussed features (as well as discussed features) are inherent from the figures themselves. Other non-discussed features may be inherent in component geometry and/or configuration. Furthermore, wherever feasible and convenient, like reference numerals are used in the figures and the description to refer to the same or like parts or steps. The figures are in a simplified form and not to precise scale.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

The present disclosure includes battery powered forklifts with an ultra-fast charging method using different converters for battery recharge. The forklift's battery can be charged with high voltage and power from the charger to reduce the charging time. This high power can be stepped down to the standard battery voltage in the converter and transferred through the busbars to the battery pack. Now, the forklifts' operators can plug the battery to the charger during their break time to reduce or eliminate the down time during operation which directly increases the efficiency in their work flow.

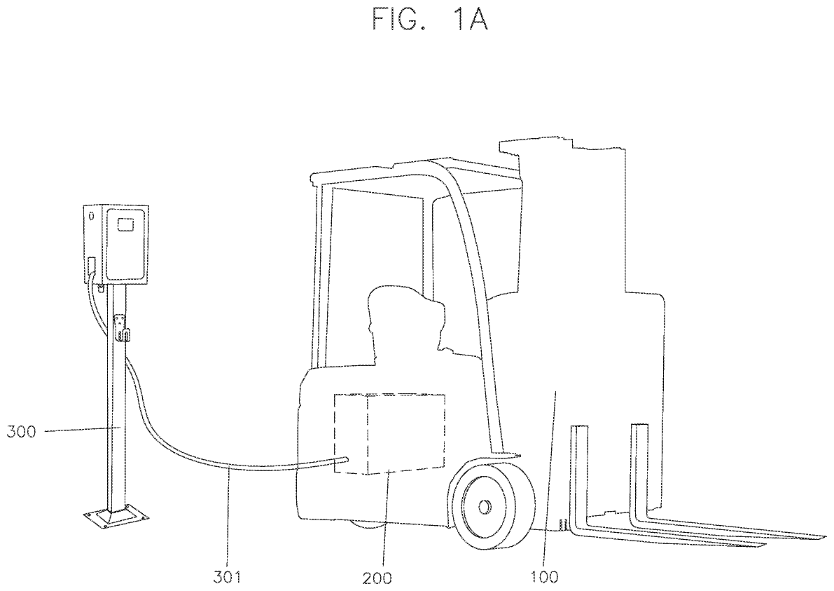

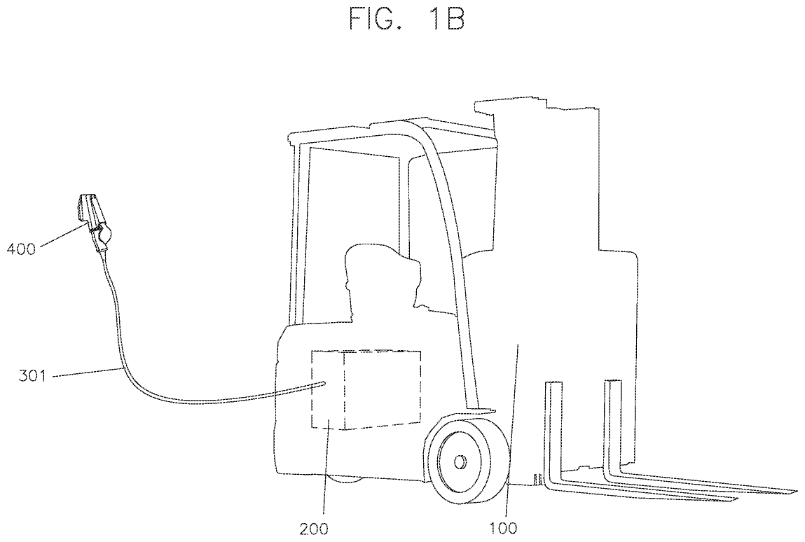

As shown in FIGS. 1A and 1B, the battery powered forklift 100 contains the battery 200 and can be connected to either a DC charger 300 or wall plug 400 depending on the converter type inside the battery. The DC charger 300 is used when the battery's built-in converter is DC-DC, the voltage is stepped-down from the charger to the standard battery voltage (e.g. 24V, 36V, 48V, and 80V). On the other hand, the AC plug 400 (single phase or three phase) is utilized with the AC-DC built-in converter where the voltage is converted to DC inside the battery. The charging cable 301 (connected from the charger to the battery) and 401 (connected from the AC plug to the battery) are able to have a high charging power while the cable and connector size is not big and bulky due to the lower amount of current needed compared to the traditional charging, which makes it easier to the operators to plug in and out.

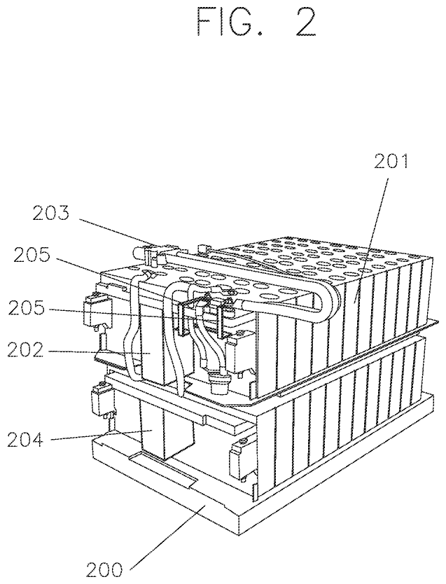

As shown in FIG. 2, the battery 200 consists of lithium ion battery pack 201, AC-DC or DC-DC converter 202, battery cables 203, battery management system 204 and busbars 205 to support the high charging current to the battery. The lithium ion batteries 201 are connected in series or/and in parallel depending on the different requested voltage. Also, the busbars 205 can be used as a copper plates or a hard wire from the converter's output to the battery pack.

Additionally, The BMS 204 is connected to the built-in converter 202 and may include Wi-Fi and/or Bluetooth Low Energy (BLE), Near Field Communication (NFC) and/or GPS and/or a GPS locator therein (shown generally as electronic components and/or as computer). The Wi-Fi capability will allow the battery to connect to the local network. The BLE capability can communicate the forklift's location within the warehouse, while the GPS can transmit the forklift's location outside the warehouse. The Wi-Fi capability will be important for integrating the battery/forklift with the warehouse's existing technology and software. The Wi-Fi may also help to monitor operators' progress and may also be used to map the fastest route for locating or completing the tasks. The Wi-Fi, BLE, NFC and GPS may also help to prevent theft of the forklift 100, as its exact position can be monitored/tracked. If lost, the battery/forklift can be found using the Wi-Fi, BLE, and GPS.

While various embodiments of devices and systems and methods for using the same have been described in considerable detail herein, the embodiments are merely offered as non-limiting examples of the disclosure described herein. It will therefore be understood that various changes and modifications may be made, and equivalents may be substituted for elements thereof, without departing from the scope of the present disclosure. For example, it is conceived the battery and related charging described herein could be used with a number of Automated Guided Vehicles (AGVs), Ground Support Equipment (GSE) and Industrial Electric Vehicles. The present disclosure is not intended to be exhaustive or limiting with respect to the content thereof.

Further, in describing representative embodiments, the present disclosure may have presented a method and/or a process as a particular sequence of steps. However, to the extent that the method or process does not rely on the particular order of steps set forth therein, the method or process should not be limited to the particular sequence of steps described, as other sequences of steps may be possible. Therefore, the particular order of the steps disclosed herein should not be construed as limitations of the present disclosure. In addition, disclosure directed to a method and/or process should not be limited to the performance of their steps in the order written. Such sequences may be varied and still remain within the scope of the present disclosure.

1.-10. (canceled)

11. A battery for use within an electric vehicle, comprising:
a battery pack;
a battery management system;
a connection for connecting the battery to a power source;
a converter for converting a voltage received from the power source to a lower battery voltage; and
at least one busbar connecting the converter to the battery pack; and
wherein the battery voltage is a standard battery voltage and the battery voltage is received by the battery pack through the at least one busbar to rapidly charge the battery pack.

12. The battery for use within an electric vehicle as in claim 11, wherein the battery pack is a lithium ion battery pack.

13. The battery for use within an electric vehicle as in claim 12, wherein the lithium ion battery pack comprises a plurality of lithium ion batteries connected in parallel.

14. The battery for use within an electric vehicle as in claim 12, wherein the lithium ion battery pack comprises a plurality of lithium ion batteries connected in series.

15. The battery for use within an electric vehicle as in claim 11, wherein the power source is a high voltage power source.

16. The battery for use within an electric vehicle as in claim 11, wherein the converter is built into the battery.

17. The battery for use within an electric vehicle as in claim 16, wherein the converter is a DC-DC converter, which steps down the voltage from the power source to the lower battery source voltage.

18. The battery for use within an electric vehicle as in claim 16, wherein the converter is an AC-DC converter which converts AC power received from the power source to DC, and also steps down the voltage from the power source to the lower battery voltage.

19. The battery for use within an electric vehicle as in claim 17, wherein the power source is a DC charger.

20. The battery for use within an electric vehicle as in claim 18, wherein the connection is an AC wall plug to connect to a power grid.

21. The battery for use within an electric vehicle as in claim 20, wherein the power source is a three-phase power source.

22. The battery for use within an electric vehicle as in claim 20, wherein the power source is a single phase power source.

23. The battery for use within an electric vehicle as in claim 11, wherein the connection comprises a charging cable and an AC plug.

24. The battery for use within an electric vehicle as in claim 11, wherein the at least one busbar comprises a copper plate.

25. The battery for use within an electric vehicle as in claim 11, wherein the at least one busbar comprises a hard wire from the converter's output to the battery pack.

26. The battery for use within an electric vehicle as in claim 11, wherein the battery management system is connected to the built-in converter and includes Wi-Fi, Bluetooth Low Energy, Near Field Communication, and/or GPS.

27.-42. (canceled)

43. A battery for use within an electric vehicle, comprising:
a battery pack which receives a battery voltage from a converter through a busbar;
wherein the converter is connected to, and receives, a high voltage power from a power source through a cable and steps down the high voltage power to the lower battery voltage, wherein the lower battery voltage has a high charging current.

44. The battery for use within an electric vehicle as in claim 11, wherein the battery is configured for use in Automated Guided Vehicles (AGVs), Ground Support Equipment (GSE), or Industrial Electric Vehicles.

45. A method for ultra-fast charging of a battery for use within an electric vehicle, comprising the steps of:
delivering a high voltage from a power source to a converter built into a battery;
converting the high voltage to a lower battery voltage;
delivering the lower battery voltage to a battery pack through at least one busbar.

46. The method for ultra-fast charging of a battery for use within an electric vehicle as in claim 45, wherein the power source is a single or three phase AC power source and the step of converting the high voltage to a battery voltage further comprises the step of converting the high voltage from AC to DC.
